(19) United States
(12) Patent Application Publication
(10) Pub. No.: US 2012/0189336 A1
(43) Pub. Date: Jul. 26, 2012

(54) TRANSFER DEVICE, IMAGE FORMING APPARATUS, AND METHOD OF CONTROLLING THE TRANSFER DEVICE

(75) Inventor: Koji TAKAHASHI, Tokyo (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/347,772

(22) Filed: Jan. 11, 2012

Related U.S. Application Data
(60) Provisional application No. 61/434,915, filed on Jan. 21, 2011.

(51) Int. Cl. G03G 15/16

(52) U.S. Cl. 399/66

(57) ABSTRACT

According to one embodiment, a transfer device includes: a transfer member configured to come into contact with an image bearing member with a predetermined pressing force and transfer a toner image onto a sheet; a supporting member configured to support the transfer member; a regulating member configured to regulate a movement amount of the supporting member; a determining section configured to determine whether a sheet is present between the image bearing member and the transfer member; and a control section configured to control the regulating member to reduce a pressing force applied when the sheet is absent between the image bearing member and the transfer member to be smaller than a pressing force applied when the sheet is present between the image bearing member and the transfer member.

### CROSS-REFERENCE TO RELATED APPLICATION

This application is based upon and claims the benefit of priority from U.S. provisional application 61/434,915, filed on Jan. 21, 2011; the entire contents of which are incorporated herein by reference.

### FIELD

Embodiments described herein relate generally to a transfer device including a transfer member that transfers an image formed on an image bearing member onto a sheet, an image forming apparatus, and a method of controlling the transfer device.

### BACKGROUND

An image forming apparatus such as a copying machine, a printer, or a facsimile apparatus employing an electrophotographic system includes a transfer member such as a transfer roller or a transfer belt. In an image forming apparatus, a sheet such as a sheet of paper passes through a contact section of an image bearing member such as a photoconductive drum and a transfer roller. A toner image formed on the image bearing member is transferred onto the sheet by the action of the transfer roller. A voltage having polarity opposite to the polarity of a toner is applied to the transfer roller. The toner image on the image bearing member is transferred onto the sheet by a field effect action of the applied voltage. The sheet having the toner image transferred thereon is conveyed to a fuser. The toner image is fixed on the sheet with heat and pressure.

For example, it is known that the pressing force of the transfer roller against a photoconductive member is changed according to a type of an image such as a character or halftone.

It is also known that the pressing force of the transfer roller against the photoconductive member is changed according to a size of a sheet.

It is also known that, when the sheet enters a nip of the transfer roller and the photoconductive member, the pressing force of the transfer roller against the photoconductive member is reduced to be smaller than the pressing force applied immediately before the sheet enters the nip.

However, the toner that cannot be cleaned remains or the toner floating in the image forming apparatus adheres to the surface of the image bearing member, which is the photoconductive member. If the sheet is absent in the nip (the contact section) of the image bearing member and the transfer roller, the toner on the image bearing member is transferred onto the transfer member according to contact of the image bearing member and the transfer roller and the transfer roller comes into contact with the rear side of the sheet conveyed to the transfer roller. Therefore, the rear side of the sheet is contaminated.

### DESCRIPTION OF THE DRAWINGS

FIG. 1 is a configuration diagram of internal structure of an image forming apparatus according to a first embodiment;

FIG. 2 is a block diagram of a hardware configuration of the image forming apparatus;

FIG. 3 is a schematic configuration diagram of a transfer device according to the first embodiment;

FIG. 4 is a flowchart for explaining the operation of the transfer device;

FIG. 5 is a graph of a relation between crossover length of a transfer roller overlapping a photoconductive member and the pressing force of the transfer roller against the photoconductive member in a second embodiment;

FIG. 6 is a configuration diagram of the crossover length of the transfer roller overlapping the photoconductive member;

FIG. 7 is a graph of a relation between a deterioration degree of a toner and image contamination of the photoconductive member in the second embodiment; and

FIG. 8 is a graph of a relation between the image contamination on the photoconductive member and contamination of the transfer roller due to the toner transferred from the photoconductive member onto the transfer roller in the second embodiment.

### DETAILED DESCRIPTION

In general, according to one embodiment, a transfer device includes: a transfer member configured to come into contact with an image bearing member with a predetermined pressing force and transfer a toner image onto a sheet; a supporting member configured to support the transfer member; a regulating member configured to regulate a movement amount of the supporting member; a determining section configured to determine whether a sheet is present between the image bearing member and the transfer member; and a control section configured to control the regulating member to reduce a pressing force applied when the sheet is absent between the image bearing member and the transfer member to be smaller than a pressing force applied when the sheet is present between the image bearing member and the transfer member.

Embodiments are explained below with reference to the accompanying drawings.

### First Embodiment

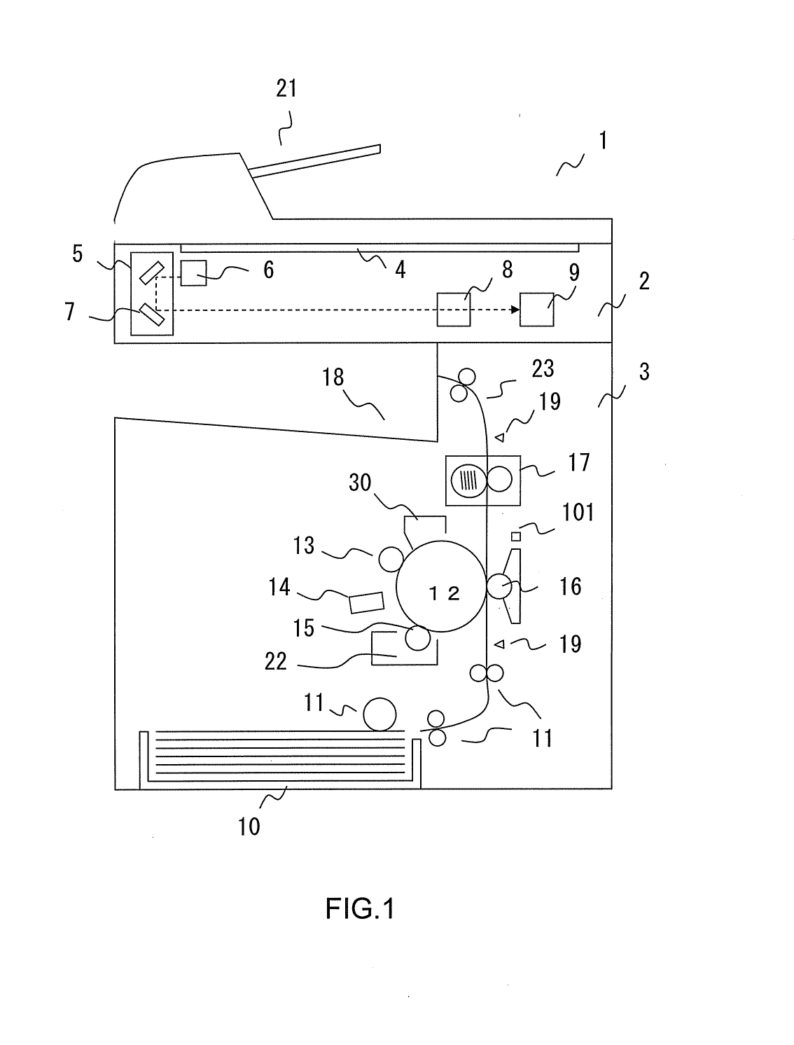

FIG. 1 is a configuration diagram of internal structure of an image forming apparatus.

An image forming apparatus 1 includes an image reading section 2 that captures an original document as image data and an image forming section 3 that outputs the image data as a visible image.

The image reading section 2 includes a transparent document placing table 4, a carriage 5, an exposure lamp 6, a reflection mirror 7, a focusing lens 8 that converges reflected light, and a CCD (Charge Coupled Device) 9 that converts image information by the reflected light into an analog signal.

The image forming section 3 includes a sheet cassette 10 that stores sheets of an arbitrary size, a sheet conveying section 11 that feeds the sheets from the sheet cassette 10, a photoconductive member 12 functioning as an image bearing member, a charging roller 13 functioning as a charging device, a laser unit 14 functioning an exposing device, a developing roller 15 functioning as a developing device, a transfer roller 16 functioning as a transfer device, a fuser 17, a sheet discharge section 18, a sheet detecting section 19, a control section 20, a timer 100, and a hygrometer 101.

An original document to be copied is placed on the document placing table 4 or set in a publicly-known auto document feeder 21 arranged on the document placing table 4. When a copy button of a not-shown operation section is pressed, an exposure lamp 6 provided in the carriage 5 irradiates light, from below the document placing table 4, on the original document on the document placing table 4 or the original document fed to an exposure position of the document placing table 4 by the auto document feeder 21. The light reflected from the original document is led by the reflection mirror 7 and converged by the focusing lens 8. A reflected light image is projected on the CCD 9. If the original document is placed on the document placing table 4, the light from the exposure lamp 6 scans the surface of the original document in synchronization with the movement of the carriage 5. After this scanning light is captured into the CCD 9 as image information, the image information is converted from an analog signal into a digital signal. Thereafter, after being subjected to image processing according to necessity, the digitized image information is transmitted to the laser unit 14 as image data. The image information converted into the digital signal may be temporarily stored in a storage device such as a HDD (Hard Disk Drive).

In the image forming section 3, the charging roller 13 supplies electric charges to the outer circumference surface of the rotating photoconductive member 12 and uniformly charges the surface of the photoconductive member 12. Subsequently, the laser unit 14 irradiates, on the surface of the photoconductive member 12, a laser beam modulated on the basis of the image data transmitted from the CCD 9. The laser beam scans the surface of the photoconductive member 12 along the direction of a rotating shaft of the photoconductive member 12 and forms an electrostatic latent image corresponding to the image data on the outer circumferential surface of the photoconductive member 12. Further, the developing device supplies a developer such as a toner to the outer circumferential surface of the photoconductive member 12 and converts the electrostatic latent image into a toner image.

The developing device includes the developing roller 15 provided to be rotatable and a toner storing section 22. The developing roller 15 is arranged to be opposed to the photoconductive member 12 and rotates, whereby the toner is supplied to the photoconductive member 12. The transfer roller 16 electrostatically transfers the toner image formed on the outer circumferential surface of the photoconductive member 12 onto a sheet conveyed by the sheet conveying section 11 through a sheet conveying path 23. The transfer roller 16 is in contact with the outer circumferential surface of the photoconductive member 12. The toner image is transferred when the sheet is passing between the photoconductive member 12 and the transfer roller 16. A mechanical section or the like that performs transfer is used as the transfer device. The transfer device is explained later. A cleaner 30 located further downstream in a rotating direction of the photoconductive member 12 than the transfer roller 16 removes the toner remaining on the photoconductive member 12 without being transferred.

The sheet having the toner image transferred thereon is conveyed to the fuser 17 by the sheet conveying section 11. The fuser 17 fixes the toner image on the sheet. A conveying roller discharges the sheet having the toner image fixed thereon onto to a paper discharge tray, which is the sheet discharge section 18.

The sheet detecting section 19 includes a sheet sensor that detects the leading end or the trailing end of a conveyed sheet. A plurality of the sheet sensors are arranged on the sheet conveying path 23. For example, one sheet sensor is arranged further on the upstream side than the transfer roller 16 in a sheet conveying direction. The sheet sensor may be either optical or mechanical. The sheet sensor outputs detected information to the control section 20.

The sheet conveying section 11 includes a sheet guide and a conveying roller. Plural sheet guides and conveying rollers are arranged on the sheet conveying path 23. As a conveying member, a belt may be provided other than the roller.

The control section 20 includes a CPU, a ROM, and a RAM and controls the entire image forming apparatus 1. For example, the control section 20 performs image processing for read image data, performs control of driving timings for and applied voltages to the laser unit, the charging device, the developing device, the transfer device, and the like, and forms an appropriate image. Further, the control section 20 controls driving of a pressing device in order to change the pressing force of the transfer roller 16 against the photoconductive member 12 according to whether a sheet is present in a contact section of the transfer roller 16 and the photoconductive member 12.

The operation of the image forming apparatus 1 shown in FIG. 1 is briefly explained. When image data is input from the image reading section 2, a personal computer, or the like, a laser beam corresponding to the image data is irradiated on the surface of the photoconductive member 12 and an electrostatic latent image is formed. The electrostatic latent image is developed by the developing device and a toner image is formed.

The sheet conveying section 11 conveys a sheet from the sheet cassette 10. The transfer roller 16 transfers the toner image on the photoconductive member 12 onto the sheet. The cleaner 30 removes the toner remaining on the photoconductive member 12 after the transfer.

The sheet having the toner image transferred thereon is conveyed to the fuser 17 by the conveying roller. The toner image is fixed on the sheet. The sheet is discharged to the paper discharge tray.

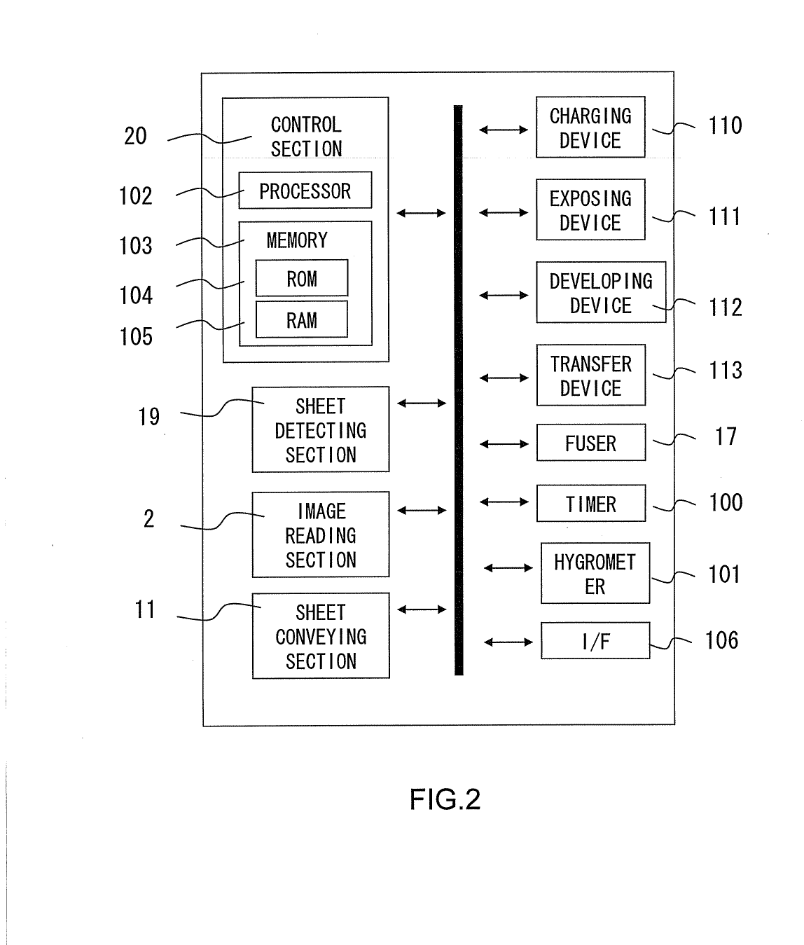

FIG. 2 is a block diagram of a hardware configuration of the image forming apparatus 1. The image forming apparatus 1 includes the control section 20, the sheet detecting sections 19, the image reading section 2, the sheet conveying section 11, a charging device 110, an exposing device 111, a developing device 112, a transfer device 113, the fuser 17, the timer 100, and the hygrometer 101.

The control section 20 includes a processor 102 including a CPU (Central Processing Unit) or an MPU (Micro Processing Unit) and a memory 103. For example, the CPU controls the image reading section 2, the sheet conveying section 11, the charging device 110, the exposing device 111, the developing device 112, the transfer device 113, the fuser 17, and the like. The memory 103 is, for example, a semiconductor memory and includes a ROM (Read Only Memory) 104 that stores various control programs and a RAM (Random Access Memory) 105 that provides the processor 102 with a temporary work area. For example, the ROM 104 stores a computer program for controlling a rotation angle of a cam 203 in order to change the pressing force of the transfer roller 16 against the photoconductive member 12 and a computer program for controlling fusing temperature of the fuser 17. The RAM 105 may temporarily store image data read by the image reading section 2. The components of the image forming apparatus 1 are connected via a bus.

The control section 20 controls the image reading section 2, the sheet conveying section 11, the charging device 110, the exposing device 111, the developing device 112, the transfer device 113, the fuser 17, and the other components. For example, the control section 20 drives, on the basis of the pressing of the copy button, the image reading section 2 to read an original document. The control section 20 controls, on the basis of read image data, the sheet conveying section 11, the charging device 110, the exposing device 111, the developing device 112, the transfer device 113, the fuser 17, and the like to form an image on a sheet. The control section 20 controls the components in the apparatus on the basis of an output signal from the sheet detecting section 19, the timer 100, or the hygrometer 101.

The timer 100 measures a conveying time for a sheet or an agitation time for a toner as explained later. The hygrometer 101 measures the humidity around the image bearing member 12.

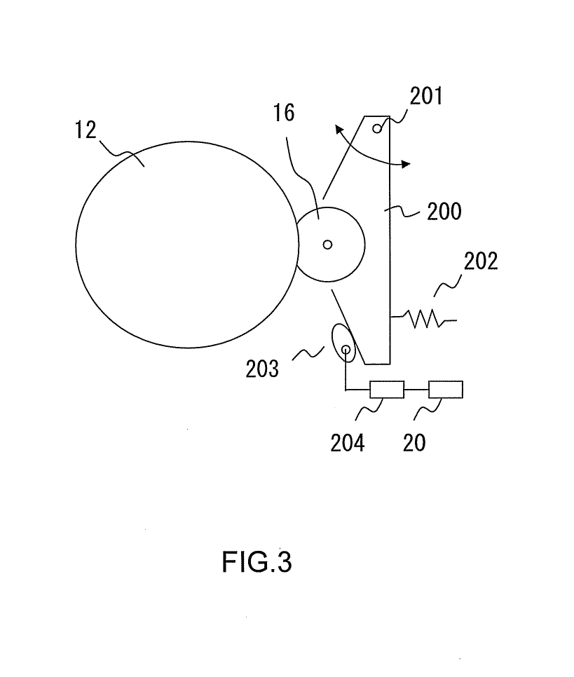

The transfer device according to this embodiment is explained. FIG. 3 is a schematic configuration diagram of the transfer device according to this embodiment.

The transfer device includes the transfer roller 16, a supporting member 200, and the pressing device.

The transfer roller 16 functioning as a transfer member is in contact with the photoconductive member 12 even when the sheet is absent between the photoconductive member (the image bearing member) 12 and the transfer roller 16. The transfer roller 16 does not include a mechanical cleaner that comes into contact with the transfer roller 16 and removes a toner on the surface of the roller 16.

The supporting member 200 rotatably supports a rotating shaft of the transfer roller 16 via a bearing. The supporting member 200 is supported by a main body frame of the image forming apparatus 1 to be rotatable about a fulcrum 201.

The pressing device includes a spring (an elastic member) 202, the rotatable cam (regulating member) 203, and a motor (a driving source) 204.

The spring 202 functioning as an elastic member is provided between the supporting member 200 and the main body frame of the image forming apparatus 1 and pushes the supporting member 200 toward the photoconductive member 12.

The cam 203 functioning as the regulating member rotates while coming into contact with the supporting member 200 to bring the supporting member 200 away from and close to the photoconductive member 12. In this embodiment, the cam 203 is provided on the photoconductive member 12 side with respect to the supporting member 200. Even if a sheet jams between the photoconductive member 12 and the transfer roller 16, since the cam 203 is provided on the photoconductive member 12 side with respect to the supporting member 200, the supporting member 200 can be easily retracted from the photoconductive member 12. Therefore, it is possible to facilitate jam treatment between the photoconductive member 12 and the transfer roller 16 and prevent the photoconductive member 12 from being scratched by the jammed sheet.

The motor 204 functioning as the driving source is coupled to the cam 203 via a link member or directly coupled to the cam 203. The control section 20 drives the motor 204 to control the rotating position of the cam 203.

When a sheet is passing between the transfer roller 16 and the photoconductive member 12, the cam 203 is present in a first rotating position. When a sheet is not passing between the transfer roller 16 and the photoconductive member 12, the cam 203 is present in a second rotating position. When the cam 203 is present in the first rotating position and the second rotating position, the transfer roller 16 is in contact with the photoconductive member 12. When the cam 203 is present in the first rotating position, the pressing force of the transfer roller 16 against the photoconductive member 12 is large. When the cam 203 is in the second rotating position, the pressing force of the transfer roller 16 against the photoconductive member 12 is small. For example, the pressing force of the transfer roller 16 applied when the cam 203 is present in the first rotating position is 860 g/cm². The pressing force of the transfer roller 16 applied when the cam 203 is in the second rotating position is 703 g/cm².

The sheet sensor 19 is arranged on the sheet conveying path 23 further on the upstream side than the transfer roller 16. The control section 20 drives the motor 204 on the basis of an output result of the sheet sensor 19 to change the rotating position of the cam 203 to the first rotating position and the second rotating position.

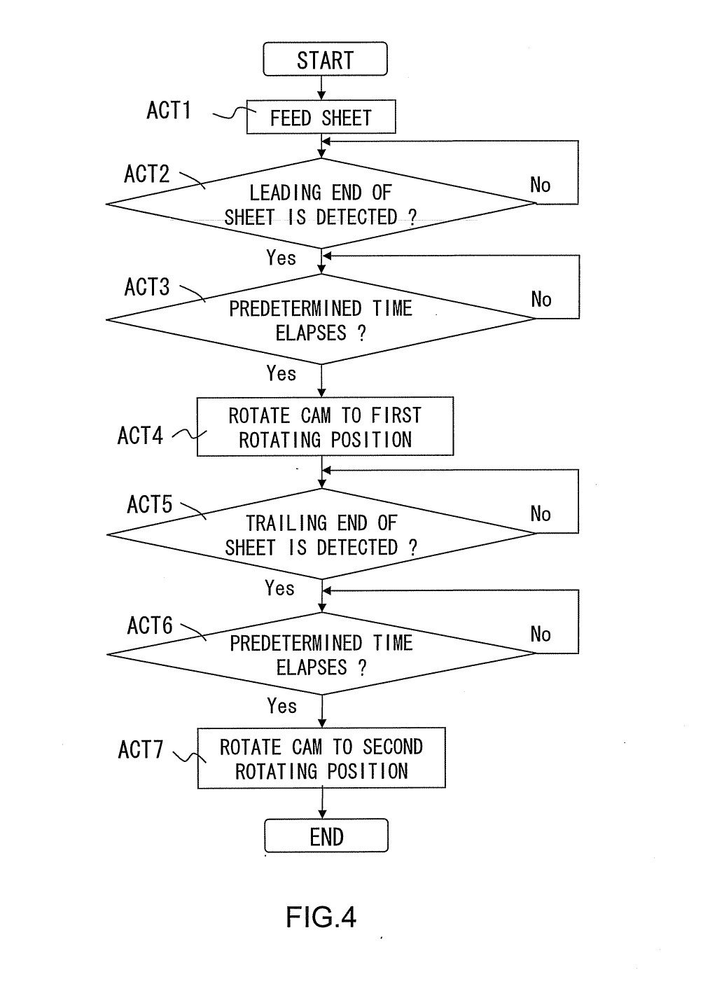

FIG. 4 is a flowchart for explaining the operation of the transfer device.

When the copy button or a start button of the image forming apparatus is pressed, the sheet conveying section 11 feeds a sheet from the sheet cassette 10 (ACT 1). The control section 20 determines whether the sheet sensor 19 detects the leading end of the sheet (ACT 2). If the sheet sensor 19 does not detect the leading end of the sheet, the control section 20 stays on standby (No in ACT 2). If the sheet sensor 19 detects the leading end of the sheet (Yes in ACT 2), the control section 20 determines whether a predetermined time elapses after the detection of the leading end of the sheet (ACT 3). If the predetermined time does not elapse (No in ACT 3), the control section 20 stays on standby. If the predetermined time elapses (Yes in ACT 3), the control section 20 rotates the cam 203 from the second rotating position to the first rotating position (ACT 4). The predetermined time is a time until the sheet reaches a nip position of the photoconductive member 12 and the transfer roller 16 after the sheet sensor 19 detects the leading end or the trailing end of the sheet. The cam 203 is present in the second rotating position until the predetermined time elapses. Therefore, the cam 203 is present in the second rotating position before the sheet passes through the nip. The cam 203 is present in the first rotating position when the sheet is passing through the nip. The control section 20 determines whether the trailing end of the sheet passes through the sheet sensor 19 (ACT 5). If the sheet sensor 19 does not detect the trailing end of the sheet, the control section 20 stays on standby (No in ACT 5). If the sheet sensor 19 detects the trailing end of the sheet (Yes in ACT 5), the control section 20 determines whether a predetermined time elapses after the sheet sensor 19 detects the trailing end of the sheet (ACT 6). If the predetermined time does not elapse, the control section 20 stays on standby (No in ACT 6). If the predetermined time elapses (Yes in ACT 6), the control section 20 rotates the cam 203 from the first rotating position to the second rotating position (ACT 7). The toner image is transferred onto the sheet from the photoconductive member 12. The sheet passes through the fuser 17 and is discharged onto the paper discharge tray. The image formation ends.

When the cam 203 is present in the second rotating position, the cam 203 pushes the supporting member 200 to the spring 202 side against the pressing force of the spring 202. The pressing force of the transfer roller 16 against the photoconductive member 12 decreases. In other words, when the sheet is not passing between the transfer roller 16 and the photoconductive member 12, the pressing force of the transfer roller 16 against the photoconductive member 12 decreases.

When the cam 203 rotates from the second rotating position to the first rotating position, since the spring 202 further pushes the supporting member 200 toward the photoconductive member 12, the pressing force of the transfer roller 16 against the photoconductive member 12 increases. In other words, when the sheet is passing between the transfer roller 16 and the photoconductive member 12, the pressing force of the transfer roller 16 against the photoconductive member 12 increases. Consequently, since the transfer roller 16 can be sufficiently pressed against the photoconductive member 12, transfer efficiency increases and the toner image on the photoconductive member 12 can be surely transferred onto the sheet.

On the other hand, when the sheet is not passing between the transfer roller 16 and the photoconductive member 12, since the pressing force of the transfer roller 16 against the photoconductive member 12 decreases, the toner on the photoconductive member 12 is less easily transferred onto the surface of the transfer roller 16. Therefore, since the toner on the transfer roller 16 is absent or few, it is possible to suppress that the rear side of the sheet is contaminated by the toner adhering to the transfer roller 16.

### Second Embodiment

A second embodiment is basically the same as the first embodiment. The second embodiment is explained more in detail. There are the two pressing forces of the transfer roller 16 against the photoconductive member 12 in the first embodiment. In the second embodiment, there are four pressing forces of the transfer roller 16.

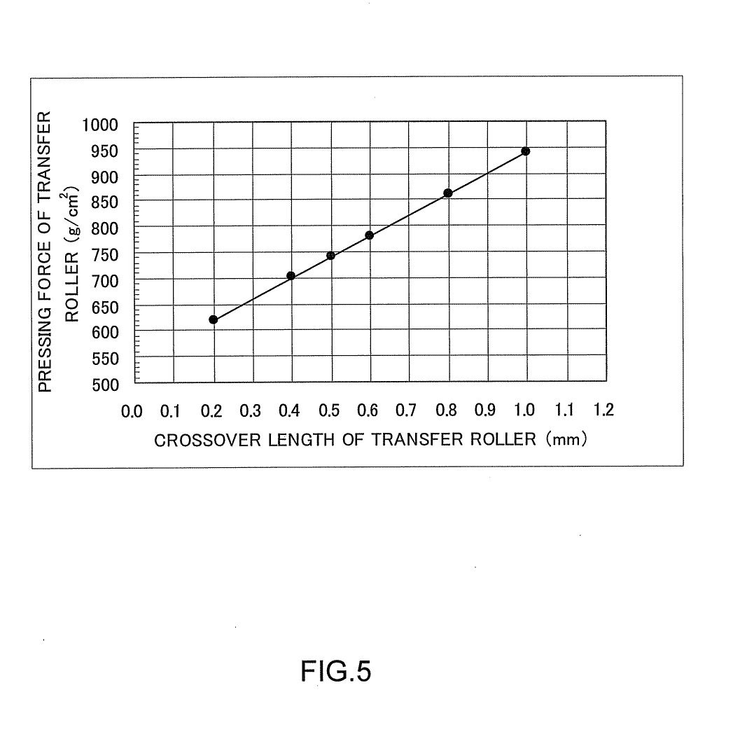

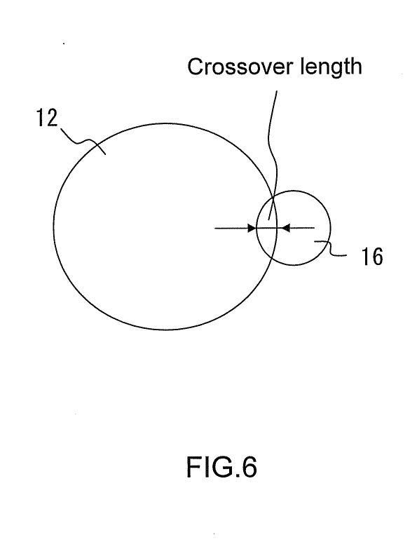

FIG. 5 is a graph of a relation between crossover length of a transfer roller overlapping a photoconductive member and the pressing force of the transfer roller against the photoconductive member. FIG. 6 is a configuration diagram of the crossover length of the transfer roller overlapping the photoconductive member. The crossover length is, as indicated by an arrow in FIG. 6, the length of a portion imaginarily overlapping the photoconductive member when the transfer roller is not elastically deformed.

Measuring conditions in FIG. 5 are as described below.

Ambient temperature: 23° C.

Ambient humidity: 50% RH

Outer diameter of the transfer roller: 28 mm

Hardness of the transfer roller: 35° under a 500 g load measurement condition (an Asker-C hardness meter is used)

Outer diameter of an aluminum roller: 26 mm

For example, under a condition in which the transfer roller was set in contact with the aluminum roller with back load of 11 kgf, the pressing force (g/cm²) of the transfer roller against the aluminum roller was measured. Crossover length and a pressing force were measured while changing a back load. It is seen from the figure that the pressing force of the transfer roller increases according to the crossover length of the transfer roller.

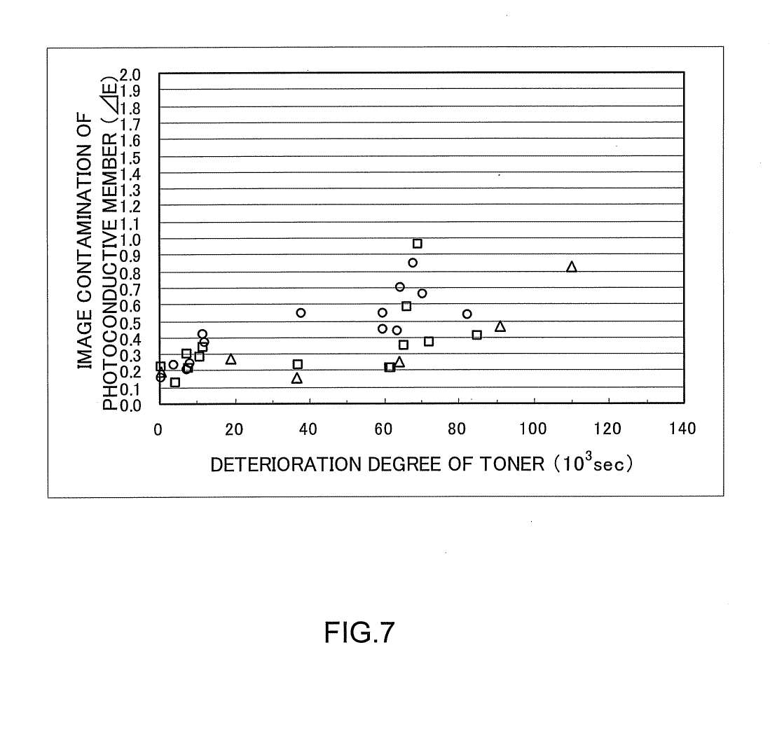

FIG. 7 is a graph of a relation between a deterioration degree of a toner and image contamination on the surface of the photoconductive member 12. The deterioration degree of the toner indicates a deterioration state of the toner. The deterioration degree of the toner is proportional to a time in which the toner is agitated in a developing device. Therefore, in this embodiment, the deterioration degree of the toner is indicated by an agitation time for the toner. The image contamination means a toner deposit amount in a non-image region on the photoconductive member 12. The non-image region on the photoconductive member 12 means a region on the photoconductive member 12 equivalent to an interval between sheets during image formation. In order to measure the image contamination, the toner adhering to the non-image region on the photoconductive member 12 is transferred onto a sheet and fixed. Image density on the sheet to which the toner adheres is optically measured. On the other hand, the density on the front side of the sheet not printed is optically measured. A density difference between the densities is calculated as image contamination. As explained later, it is also possible to sample, with a tape, the toner adhering to the photoconductive member without printing the sheet with the toner, measure the density of the toner, and calculate image contamination of the photoconductive member.

In general, it is known that, as the number of printed sheets increases and the time in which the toner is agitated in the developing device increases, the toner is deteriorated, a charging amount of the toner decreases, the toner scatters or floats in a region other than an electrostatic latent image, and the toner tends to adhere to the non-image region on the photoconductive member. In other words, as the toner is agitated in the developing device longer, the deterioration degree of the toner increases and the toner tends to adhere to the non-image region on the photoconductive member. Then, as shown in FIG. 7, it is seen that the image contamination of the photoconductive member increases according to the deterioration degree of the toner.

As measurement conditions in FIG. 7, ambient temperature was set to 23° C., ambient humidity was set to 50% RH, and sheet conveying speed of a printing apparatus was set to 150 mm/sec. A monochrome printing test was performed at an occupancy ratio (a printing ratio) 8% of an image with respect to a sheet. As explained above, the image contamination increased in proportion to the deterioration degree of the toner. At an initial stage, the image contamination was 0.2. The image contamination increased to 0.9 according to the deterioration degree of the toner.

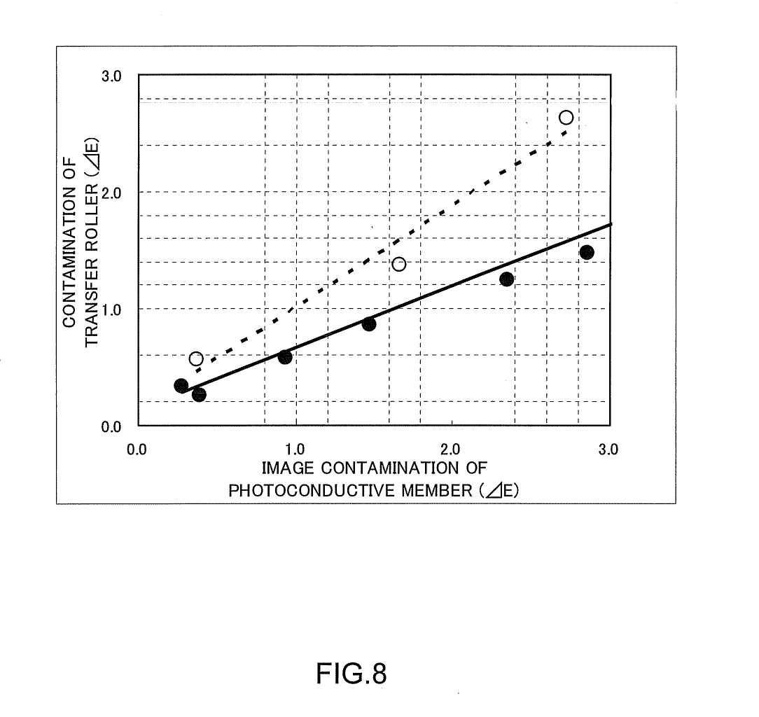

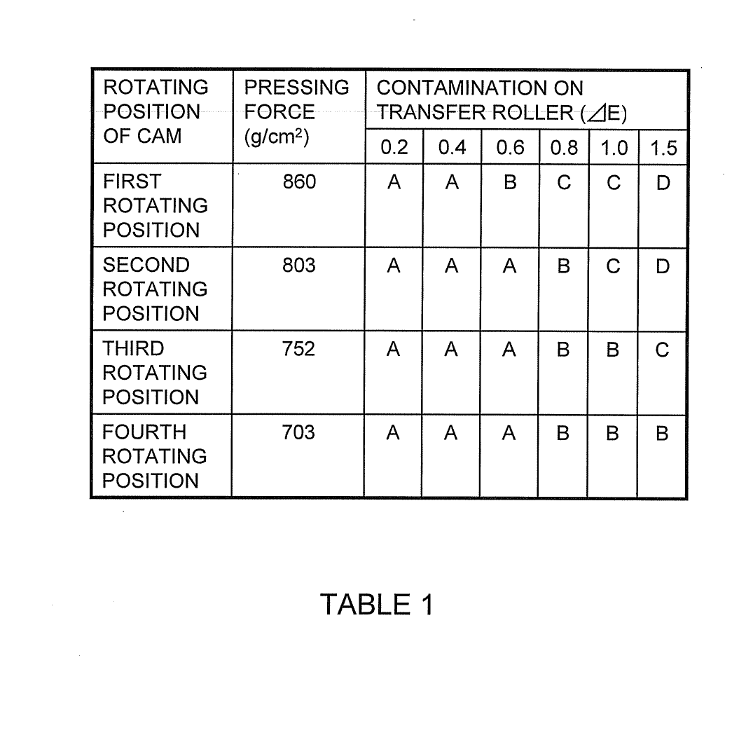

A ratio of transfer of the image contamination on the photoconductor member 12 onto the transfer roller 16 depends on the pressing force of the transfer roller 16 against the photoconductive member 12. FIG. 8 is a graph of a relation between the image contamination on the photoconductive member 12 and contamination of the transfer roller 16 due to the toner transferred onto the transfer roller 16 from the photoconductive member 12. Cases in which the pressing force of the transfer roller 16 against the photoconductive member 12 is 703 g/cm² and 860 g/cm² are plotted. In order to measure the image contamination on the photoconductive member 12 and the contamination of the transfer roller 16, printing of a predetermined number of sheets was performed in the printing apparatus, the toner on the surface of the photoconductive member 12 and the surface of the transfer roller 16 was sampled by a transparent tape after the printing of the predetermined number of sheets, and the density on the tape to which the toner adhered was optically measured. The density on the tape to which the toner did not adhere was also optically measured. AE indicates a difference between the density on the tape to which the sampled toner adhered and the density on the tape to which the toner did not adhere. The same sampling and measurement were performed while changing the number of printed sheets to 100, 500, 1000, and the like. Black circles in FIG. 8 indicate measurement values at the time when the pressing force of the transfer roller 16 was 703 g/cm². White circles indicate measurement values at the time when the pressing force of the transfer roller 16 was 860 g/cm². As shown in FIG. 8, as the pressing force of the transfer roller against the photoconductive member is lower, the contamination of the transfer roller can be suppressed. Therefore, the contamination of the rear side of the sheet can also be suppressed.

Table 1 is explained. Table 1 is a table of a relation among the pressing force of the transfer roller on the photoconductive member, the contamination on the transfer roller, and the contamination of the rear side of the sheet. In each of the four pressing forces of the transfer roller 16 on the photoconductive member 12, a relation between the contamination on the transfer roller 16 and the contamination of the rear side of the sheet was examined. As the pressing forces of the transfer roller 16, a first pressing force was set to 860 g/cm², a second pressing force was set to 803 g/cm², a third pressing force was set to 752 g/cm², and a fourth pressing force was set to 703 g/cm². When the contamination (ΔE) on the transfer roller 16 was 0.2, 0.4, 0.6, 0.8, and 1.0, contamination of the rear side of the sheet was evaluated as described below.

A: contamination of the sheet is absent
B: slight contamination is present at the ends of the sheet but is not conspicuous
C: contamination is present at the ends of the sheet but is not conspicuous (in an allowable range)
D: contamination is present on the sheet and is clearly conspicuous

As it is seen from Table 1, if the contamination on the transfer roller 16 is serious, the rear side of the sheet is seriously contaminated if the pressing force of the transfer roller 16 is high. However, the contamination of the rear side of the sheet can be reduced if the pressing force of the transfer roller 16 is low.

When the pressing force of the transfer roller 16 is low, even if the contamination on the transfer roller 16 is serious, the contamination of the rear side of the sheet can be reduced.

In other words, if the pressing force of the transfer roller 16 on the photoconductive member 12 is low, the contamination on the transfer roller 16 is less easily transferred onto the rear side of the sheet. The contamination of the rear side of the sheet can be suppressed.

In this embodiment, the pressing force applied when the sheet is passing between the photoconductive member 12 and the transfer roller 16 is represented as the first pressing force. The pressing forces applied when the sheet is not passing between the photoconductive member 12 and the transfer roller 16 are represented as the second to fourth pressing forces. When the sheet is not passing between the photoconductive member 12 and the transfer roller 16, taking into account the image contamination on the photoconductive member 12 or the contamination on the transfer roller 16, the control section 20 of the image forming apparatus 1 selects the second to fourth pressing forces. In order to change the pressing force, the control section 20 controls the rotation angle of the cam shown in FIG. 3 at plural steps or steplessly.

For example, the charging amount of the toner runs short according to the deterioration of the toner and the toner scattering increases. Therefore, it is advisable to reduce the pressing force of the transfer roller 16 according to the deterioration degree of the toner. As explained above, the deterioration degree of the toner is proportional to the agitation time for the toner in the developing device or the toner cartridge. Therefore, in this embodiment, the pressing force of the transfer roller 16 is reduced according to increase of the agitation time for the toner. The agitation time for the toner is measured by the timer 100 shown in FIG. 2. Therefore, the control section 20 controls the rotating position of the cam 203 and changes the pressing force of the transfer roller 16 according to the measurement result.

In color printing, since a toner layer of a toner image is thicker than that in monochrome printing, toner scattering tends to occur. Therefore, it is advisable to reduce the pressing force of the transfer roller 16 more in the color printing than in the monochrome printing. The control section 20 determines, on the basis of an output result from the CCD 9 of the image reading section 2, which of the color printing and the monochrome printing is performed. The control section 20 determines, on the basis of information received from an external apparatus such as a personal computer via an interface (I/F) 106 shown in FIG. 2, which of the monochrome printing and the color printing is performed. The control section 20 controls the rotating position of the cam 203 according to a result of the determination and changes the pressing force of the transfer roller 16.

In the color printing, compared with the monochrome printing, plural photoconductive members or plural developing devices are present. Therefore, an amount of the toner scattering to the non-image region or a floating amount of the toner due to toner deterioration increases in proportion to the number of photoconductive members or developing devices. Therefore, it is advisable to further reduce the pressing force of the transfer roller 16 in the color printing than in the monochrome printing.

If the humidity around the image bearing member 12 is high, since the charging amount of the toner decreases, the toner scattering tends to occur. Therefore, it is advisable to change the pressing force of the transfer roller 16 according to the humidity around the image bearing member 12. For example, if the humidity is higher than a predetermined threshold, it is advisable to further reduce the pressing force of the transfer roller 16. The humidity around the image bearing member 12 is measured by a hygrometer provided in the image forming apparatus 1 or the armor of the image forming apparatus 1. The control section 20 controls the rotating position of the cam 203 according to a result of the measurement and changes the pressing force of the transfer roller 16.

In the embodiments, the photoconductive member is used as the image bearing member. However, the image bearing member may be an intermediate transfer member. Further, the image bearing member may be either a drum-like or a belt-like image bearing member.

In the embodiments, the transfer roller is used as the transfer member. However, a blade, a brush, or the like may be used.

In the embodiments, the frame is used as the supporting member. However, the rotating shaft of the transfer roller or a bearing that supports the rotating shaft of the transfer roller may be used as the supporting member.

In the embodiments, the spring functioning as the elastic member is set in contact with the frame functioning as the supporting member. However, the spring may be directly set in contact with the rotating shaft of the transfer roller or the bearing for the rotating shaft.

In the embodiments, the compressed spring is used as the elastic member. However, a helical extension spring that pulls the supporting member from the image bearing member side may be used.

In the embodiments, the cam functioning as the regulating member is set in contact with the frame functioning as the supporting member. However, the cam may be directly set in contact with the rotating shaft of the transfer roller or the bearing for the rotating shaft.

In the embodiments, the cam is used as the regulating member. However, a solenoid or the like may be used.

While certain embodiments have been described, these embodiments have been presented by way of example only, and are not intended to limit the scope of invention. Indeed, the novel apparatus, methods and system described herein may be embodied in a variety of other forms; furthermore, various omissions, substitutions and changes in the form of the apparatus, methods and system described herein may be made without departing from the spirit of the inventions. The accompanying claims and their equivalents are intended to cover such forms or modifications as would fall within the scope and spirit of the inventions.

What is claimed is:

1. A transfer device comprising:
a transfer member configured to come into contact with an image bearing member with a predetermined pressing force and transfer a toner image onto a sheet;
a movable supporting member configured to support the transfer member;
a regulating member configured to regulate a movement amount of the supporting member;
a determining section configured to determine whether a sheet is present between the image bearing member and the transfer member; and
a control section configured to control the regulating member to reduce a pressing force applied when the sheet is absent between the image bearing member and the transfer member to be smaller than a pressing force applied when the sheet is present between the image bearing member and the transfer member.

2. The device according to claim 1, wherein the transfer member is in contact with the image bearing member when the sheet is absent between the image bearing member and the transfer member.

3. The device according to claim 1, wherein a cleaner that cleans a toner adhering to the transfer member is not in contact with the transfer member.

4. The device according to claim 1, wherein the control section changes, according to a deterioration degree of a toner, the pressing force applied when the sheet is absent between the image bearing member and the transfer member.

5. The device according to claim 1, wherein the control section changes, according to ambient humidity, the pressing force applied when the sheet is absent between the image bearing member and the transfer member.

6. The device according to claim 1, wherein the control section changes, according to whether an image to be printed is monochrome or color, the pressing force applied when the sheet is absent between the image bearing member and the transfer member.

7. The device according to claim 1, wherein the regulating member is provided on the image bearing member side with respect to the supporting member.

8. An image forming apparatus comprising:
a developing device configured to form a toner image on an image bearing member;
a transfer device configured to come into contact with the image bearing member with a predetermined pressing force and transfer the toner image onto a sheet;
a pressing device configured to change the predetermined pressing force;
a determining section configured to determine whether a sheet is present between the image bearing member and the transfer device; and
a control section configured to control the pressing device to reduce a pressing force applied when the sheet is absent between the image bearing member and the transfer device to be smaller than a pressing force applied when the sheet is present between the image bearing member and the transfer device.

9. The apparatus according to claim 8, wherein the transfer device is in contact with the image bearing member when the sheet is absent between the image bearing member and the transfer device.

10. The apparatus according to claim 8, wherein a cleaner that cleans a toner adhering to the transfer device is not in contact with the transfer device.

11. The apparatus according to claim 8, wherein the control section changes, according to a deterioration degree of a toner, the pressing force applied when the sheet is absent between the image bearing member and the transfer device.

12. The apparatus according to claim 8, wherein the control section changes, according to ambient humidity, the pressing force applied when the sheet is absent between the image bearing member and the transfer device.

13. The apparatus according to claim 8, wherein the control section changes, according to whether an image to be printed is monochrome or color, the pressing force applied when the sheet is absent between the image bearing member and the transfer device.

14. The apparatus according to claim 8, wherein
the transfer device includes:
a transfer member configured to transfer the toner image onto the sheet; and
a supporting member configured to support the transfer member,
the pressing device includes:
an elastic member configured to push the supporting member toward the image bearing member; and
a regulating member configured to regulate a movement amount of the supporting member, and
the regulating member is provided on the image bearing member side with respect to the supporting member.

15. A method of controlling a transfer device configured to transfer an image onto a sheet, the method comprising:
transferring, with a transfer member configured to come into contact with an image bearing member with a predetermined pressing force, a toner image on the image bearing member onto the sheet;
supporting the transfer member with a movable supporting member;
regulating a movement amount of the supporting member;
determining whether the sheet is present between the image bearing member and the transfer member; and
controlling the regulating member to reduce a pressing force applied when the sheet is absent between the image bearing member and the transfer member to be smaller than a pressing force applied when the sheet is present between the image bearing member and the transfer member.

16. The method according to claim 15, wherein the transfer member is in contact with the image bearing member when the sheet is absent between the image bearing member and the transfer member.

17. The method according to claim 15, wherein the controlling includes changing, according to a deterioration degree of a toner, the pressing force applied when the sheet is absent between the image bearing member and the transfer member.

18. The method according to claim 15, wherein the controlling includes changing, according to ambient humidity, the pressing force applied when the sheet is absent between the image bearing member and the transfer member.

19. The method according to claim 15, wherein the controlling includes changing, according to whether an image to be printed is monochrome or color, the pressing force applied when the sheet is absent between the image bearing member and the transfer member.

20. The method according to claim 15, wherein the regulating includes regulating movement of the supporting member from the image bearing member side.
